(19) United States
(12) Patent Application Publication
(10) Pub. No.: US 2002/0190508 A1
(43) Pub. Date: Dec. 19, 2002

(54) Headliner assembly having an integral air bag and method of making the same

(75) Inventor: Stefan Jost, Eppstein (DE)

Correspondence Address: Pete N. Kiousis, Brooks & Kushman P.C., 22nd Floor, 1000 Town Center, Southfield, MI, 48075-1351, US

(73) Assignee: LEAR CORPORATION, Southfield, MI

(21) Appl. No.: 10/174,605

(22) Filed: Jun. 19, 2002

Related U.S. Application Data
(60) Provisional application No. 60/299,289, filed on Jun. 19, 2001.

(51) Int. Cl. B60R 21/22

(52) U.S. Cl. 280/730.2

(57) ABSTRACT

A vehicle headliner assembly having a headliner having a first surface, a second surface, and at least one side edge. The assembly also includes an air bag placed on the second surface of the headliner proximate the side edge. A surface fabric is also included covering at least a portion of the first surface of the headliner and folded over the edge such that the surface fabric covers at least a portion of the air bag. At least a portion of the surface fabric is secured to the second surface of the vehicle headliner. A method of making the wafers is also disclosed.

### CROSS-REFERENCE TO RELATED APPLICATIONS

This application claims the benefit of U.S. provisional application Serial No. 60/299,289 filed Jun. 19, 2001.

### BACKGROUND OF THE INVENTION

1. Field of the Invention

The invention relates to a headliner having an integral air bag and method of making the same.

2. Background Art

It is well known to arrange air bag modules in vehicle headliners. In the event of an accident, the air bag module deploys an air bag to cover the side windows of the motor vehicle to protect a vehicle occupant from hitting the glass or vehicle body, to prevent glass from flying into the interior of the vehicle, and to prevent the occupants from being thrown out of the vehicle.

Various methods have been designed to attach the air bag modules to the headliner. For example, air bag modules have been bolted to the vehicle roof or molded integrally to the vehicle roof. Each method has its drawbacks.

Accordingly, it is desirable to provide a headliner having an air bag curtain attached thereto.

### SUMMARY OF THE INVENTION

The present invention provides a vehicle headliner assembly that is both inexpensive and easy to manufacture.

The present invention includes a method of making a headliner assembly having an integral air bag for a vehicle. The method includes the step of providing a headliner having a first surface, a second surface, and at least one side edge. An air bag is placed on the second surface of the headliner proximate the at least one edge of the headliner. A surface fabric is provided to cover at least a portion of the first surface of the headliner. Lastly, the surface fabric is secured to the headliner so that the surface fabric covers at least a portion of the first surface of the headliner and a portion of the surface fabric folds over the at least one edge of the headliner covering the air bag. The portion of the surface fabric is then secured to the second surface of the air bag such that the air bag is restrained between the surface fabric and the second surface of the headliner.

The present invention also includes a vehicle headliner assembly having a headliner having a first surface, a second surface, and at least one side edge. The assembly also includes an air bag placed on the second surface of the headliner proximate the side edge. A surface fabric is also included covering at least a portion of the first surface of the headliner and folded over the edge such that the surface fabric covers at least a portion of the air bag. At least a portion of the surface fabric is secured to the second surface of the vehicle headliner.

The above objects and other objects, features and advantages of the invention are more readily understood from a review of the attached drawings and the accompanying specification and claims.

### BRIEF DESCRIPTION OF THE DRAWINGS

FIG. 1 is a side view of a deployed air bag according to the present invention in a motor vehicle;

FIG. 2 is a sectional view of the headliner of the present invention;

FIG. 3 is a perspective view of the back side of the headliner;

FIG. 4 is a flow chart illustrating a method of making the headliner assembly of the present invention;

FIG. 5 is a top plan view of a second embodiment of a headliner assembly; and

FIG. 6 is a cross-sectional view of the second embodiment of the headliner assembly along lines 6-6.

### DETAILED DESCRIPTION OF THE PREFERRED EMBODIMENT(S)

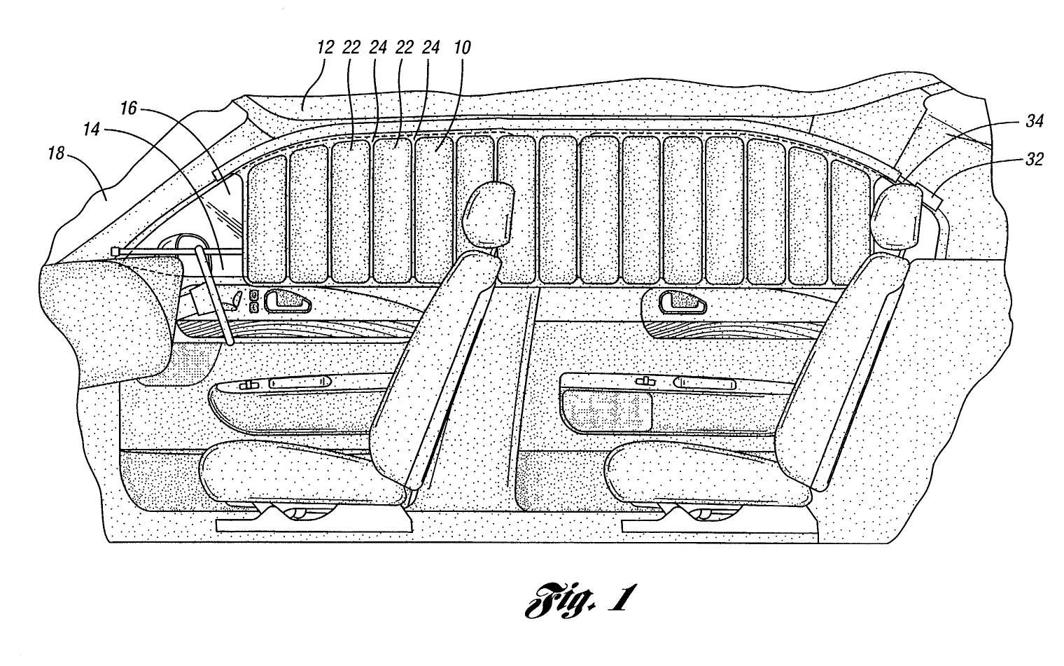

FIG. 1 shows a side view of a deployed air bag 10 inside a motor vehicle 1. The air bag 10 preferably extends from the vehicle headliner 12 down to approximately the lower edge 14 of the side windows 16 of the vehicle. Preferably, the air bag 10 extends from the front windshield 18 to cover the rear side windows (not shown) or protect the occupants. The purpose of the air bag 10 is to protect vehicle occupants (not shown) from hitting the side of the vehicle or glass, having glass fly into the vehicle interior, and to prevent the vehicle occupants from being thrown out of the vehicle.

The air bag 10 is preferably manufactured out of a woven material as is well known in the art. The air bag may be of a unitary structure or comprise sections that are sewn, welded, or otherwise fastened together. Chambers 22 may be formed in the air bag by creating seams 24 in the air bag. The chambers 22 provide extra localized padding to further protect the occupant.

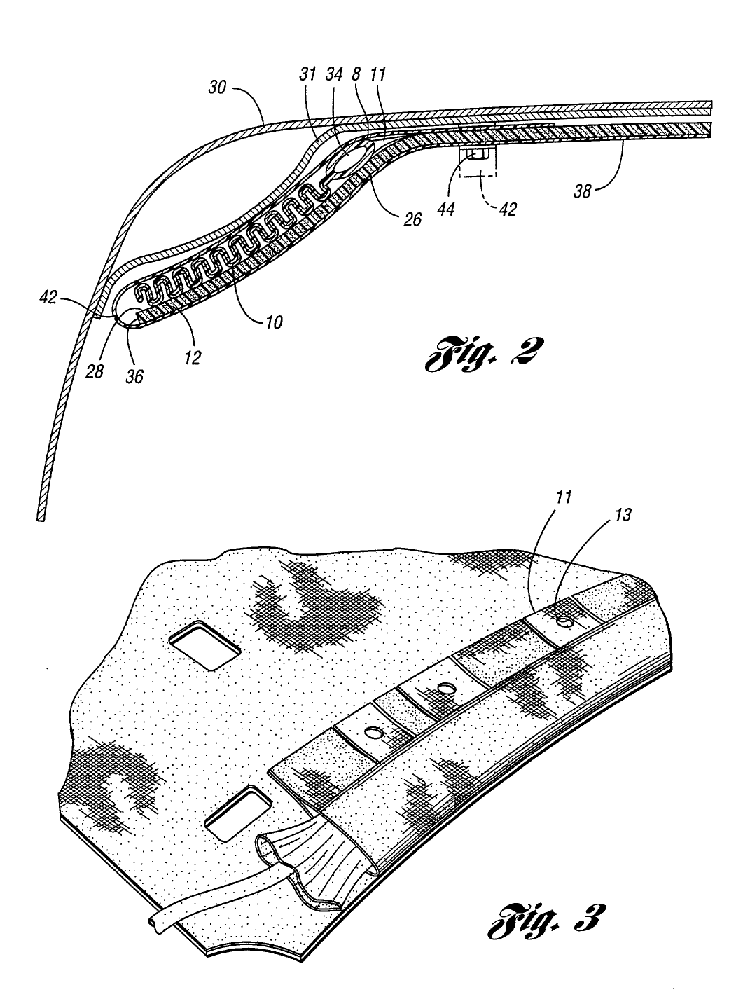

Referring to FIGS. 2-5, the headliner 12 is manufactured out of a polymeric substrate such as polyethylene is shown. The particular material or process for making the headliner is not critical to this invention. In fact, under certain circumstances, the current headliner may be used in conjunction with this invention without any modifications to the headliner. The headliner 12 has an interior surface 26 which faces the interior of the vehicle and an exterior surface 28 which faces, for example, the vehicle roof 30 or a portion of a trim panel 31. The trim panel 31 may provide support for the air bag 10 or help direct the deployment of the air bag.

The headliner 12 may be attached to the vehicle using a variety of methods. The particular method of attaching the headliner to the vehicle is not important to this invention. For example, a handle 42 having a bolt 44 may be used to secure the headliner to the vehicle roof 30. The headliner may be supported by a door seal (not shown) or an interior trim panel 31 at other locations.

An air bag module 8 having a folded air bag 10, an inflator 32, and a passageway 34 is shown positioned on top of the exterior surface 28 of the headliner approximate a edge 36. Preferably, the passageway is a flexible hose that may be manufactured out of a flexible polymer or a woven material to allow it to bend and take a required shape. Alternatively, the passageway 34 may simply be a portion of the air bag attached to itself in such a way that a duct is formed. As shown in FIG. 3, the air bag 10 is provided with a plurality of mounting tabs 11, each tab having a mounting aperture 13. The mounting tabs 11 are used to secure the air bag 10 to the vehicle roof 30 so that when the air bag deploys, at least a portion of it stays stationary to help direct deployment of the air bag. The bolt 44 of handle 42 may be inserted through the mounting apertures 13 to secure the air bag 10 to the vehicle roof 30. Alternatively, other methods of securing the air bag 10 to the vehicle roof 30 may be used.

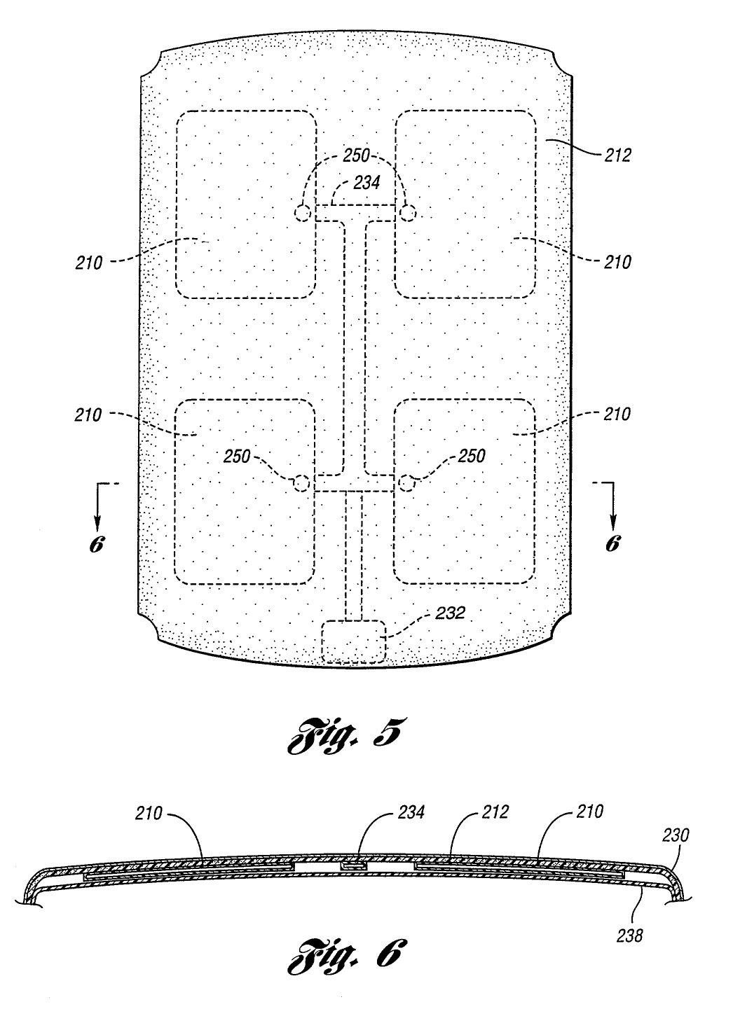

Another air bag module (not shown) may be placed at an opposite side of the headliner to protect a vehicle occupant sitting on the opposite side of the vehicle. Additionally, an air bag may be placed in a vertical direction for head protection as shown in FIG. 5.

A piece of fabric 38 having an A-surface is cut such that it covers the interior surface 26 of the headliner and folds over the side 36 of the headliner to cover the air bag 10 and the passageway 34. The A-surface covers the interior surface 26 of the headliner and is visible to a vehicle occupant. As shown in FIG. 3, the fabric 38 has tabs 40 which may extend over the air bag 10 to secure the fabric 38 to the exterior surface 28 of the headliner. The tabs 40 may be secured to the exterior surface 28 of the headliner using, for example, an adhesive.

A tear seam 42 is provided on the fabric 38 to facilitate deployment of the air bag 10. When the fabric 38 is installed on the headliner 12, the tear seam 42 is located proximate the side 36 of the headliner. The tear seam 42 can be created by lasering, scoring, or notching the fabric either before or after the fabric 38 is attached to the headliner 12. Of course, one skilled in the art could devise alternative methods for creating the tear seam.

When the vehicle is involved in an accident, a crash sensor (not shown) sends information to a controller (not shown). If the accident is severe enough, the controller sends a signal to the inflator 32 which causes the inflator to produce gas in a known manner. The produced gas travels along the passageway 34 towards the air bag 10. The passageway 34 has a plurality of holes or openings (not shown) that communicate with the air bag 10 to disperse the gas into the air bag and cause the air bag to inflate. As the air bag 10 receives the produced gas and begins to expand, the air bag exerts pressure on the fabric 38. The fabric 38 has a weak point along the tear seam 42 which gives allowing the inflating air bag 10 to deploy into the interior of the vehicle.

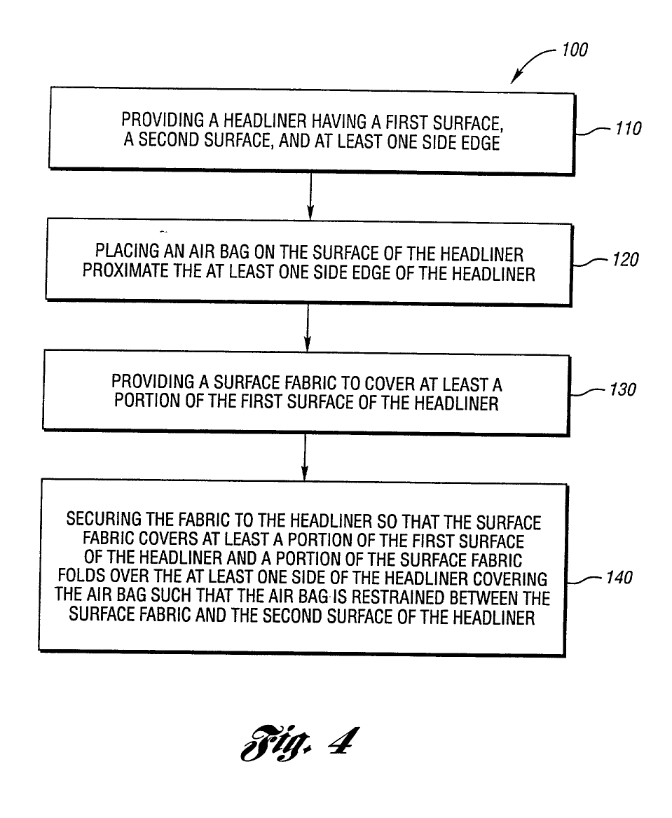

The invention also provides a method of assembling an air bag curtain to a vehicle headliner, the method is denoted as 100 and generally depicted in FIG. 4. The method includes the step 110 of providing a headliner as described above. The headliner has a first surface, a second surface, and at least one side edge. Step 120 entails placing the air bag on the second surface of the headliner proximate the edge of the headliner. Next, step 130 involves providing a surface fabric to cover at least a portion of the first surface of the headliner. The last step 140 entails securing the surface fabric to the headliner so that the surface fabric covers at least a portion of the first surface of the headliner. A portion of the surface fabric folds over the at least one edge of the headliner and covers the air bag. The portion of the surface fabric is secured to the second surface of the air bag such that the air bag is restrained between the surface fabric and the second surface of the headliner.

Referring now to FIGS. 5 and 6, a second embodiment of a headliner assembly is shown. A headliner 212 having an interior or first surface 216 is provided. At least one air bag 210 is placed on the first surface 216 of the headliner such that the air bag would be approximately over a passenger in the vehicle when the headliner is installed in a vehicle. The air bags 210 may be secured to the headliner 212 using a variety of methods such as bolts 250 in one or more locations. Of course, one skilled in the art could secure the air bags using, for example, adhesive, hook and loop fasteners, or snaps. The air bags 210 are in communication with an inflator 232 via passageways 234. The air bag 210, inflator 233, and passageways 234 may be of the type previously described. A surface fabric 238 covers at least a portion of the first surface 216 and the air bags 210 and is secured to the headliner 212. The surface fabric may fold over the edges of the headliner 212 and be secured to the second surface of the headliner, or, alternatively, the surface fabric may be secured to the first surface 216 of the headliner.

The shape of the air bags 210 and passageways 234 will vary to accommodate different vehicles.

When an impact of sufficient severity or type is detected, the controller (not shown) signals the inflator 232 to produce gas to inflate the air bags 210. The air bags 210 inflate to protect the head of the occupant in case of a roll over accident or in case the occupant is not wearing a seat belt. The air bag 210 may burst through a tear seam provided on the surface fabric 238 as described above or may inflate under the surface fabric.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a headliner assembly having an integral air bag for a vehicle, the method comprising:
providing a headliner having a first surface, a second surface, and at least one side edge;
placing an air bag on the second surface of the headliner proximate the at least one edge of the headliner;
providing a surface fabric to cover at least a portion of the first surface of the headliner; and
securing the surface fabric to the headliner so that the surface fabric covers at least a portion of the first surface of the headliner and a portion of the surface fabric folds over the at least one edge of the headliner covering the air bag, and the portion of the surface fabric is secured to the second surface of the air bag such that the air bag is restrained between the surface fabric and the second surface of the headliner.

2. The method of claim 1 further comprising piercing the surface fabric about the portion of the fabric that folds over the headliner to facilitate deployment of the air bag.

3. The method of claim 1 wherein the step of securing the surface fabric to the headline comprises providing the portion of the surface fabric that folds over the at least one edge with tabs and securing the tabs to the second surface of the headliner.

4. The method of claim 1 wherein the headliner has an aperture for securing the headliner to the vehicle and the air bag has an aperture in alignment with the aperture in the headliner when the air bag is secured to the headliner.

5. A vehicle headliner assembly comprising:
a headliner having a first surface, a second surface, and at least one side edge;
an air bag placed on the second surface of the headliner proximate the side edge; and
a surface fabric covering at least a portion of the first surface of the headliner and folded over the edge such that the surface fabric covers at least a portion of the air bag; and wherein at least a portion of the surface fabric is secured to the second surface of the vehicle headliner.

6. The headliner assembly of claim 5 wherein the surface fabric comprises a tear seam proximate the edge of the headliner.

7. The headliner assembly of claim 5 wherein the air bag comprises at least one tab having an aperture therein to secure the air bag to the vehicle.

8. The headliner assembly of claim 5 wherein the headliner has an aperture for securing the headliner to the vehicle and the air bag has an aperture in alignment with the aperture in the headliner when the air bag is secured to the headliner.

9. A headliner assembly for a motor vehicle comprising:
a headliner having a first surface, a second surface, and at least one edge;
at least one air bag placed on the first surface of the headliner; and
a surface fabric covering at least a portion of the first surface of the headliner and secured to at least one of the first or the second surface of the headliner such that the surface fabric covers the air bag.

10. The headliner assembly of claim 9 wherein the surface fabric restrains the air bag.

11. The headliner assembly of claim 9 wherein the at least one air bag is secured to the headliner.

12. The headliner assembly of claim 9 wherein the surface fabric is folded over the edge of the headliner and secured to the second side of the headliner.
